(19) United States
(12) Patent Application Publication
(10) Pub. No.: US 2009/0099909 A1
(43) Pub. Date: Apr. 16, 2009

(54) System and Method for Setting Bid Prices Associated with Digital Advertisements Based on Market Conditions

(75) Inventor: Thomas Phan, San Jose, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/870,004

(22) Filed: Oct. 10, 2007

(51) Int. Cl. G06Q 30/00

(52) U.S. Cl. 705/14

(57) ABSTRACT

Systems and methods for setting a bid price associated with a digital ad are disclosed. Generally, an ad campaign management system calculates a segmented budget for an ad campaign comprising a digital ad. The ad campaign management system runs the ad campaign for a defined period of time to determine at least a click-through rate associated with the digital ad. The ad campaign management system examines an actual cost-per-click (“actual CPC”) and a contractual cost-per-click (“contractual CPC”) associated with the digital ad to determine a calculated cost-per-click (“calculated CPC”) associated with the digital ad for a segment of the ad campaign. The ad campaign management system then sets a bid price for the digital ad based on the calculated CPC for a future segment of the ad campaign.

### BACKGROUND

Internet advertising delivery companies (“ad providers”) such as Yahoo! Inc. (www.yahoo.com) typically sell webpage advertisement placements for the placement of digital ads in terms of either guaranteed deliveries or non-guaranteed deliveries. With respect to guaranteed deliveries, an ad provider guarantees to serve a set number of digital ads, which are typically graphical ads, for a predetermined fee. With respect to non-guaranteed deliveries, an ad provider does not guarantee to serve a set number of digital ads, but when the ad provider does serve a digital ad, an advertiser agrees to compensate the ad provider a defined amount based on an action associated with served digital ad, such as compensating the ad provider per each impression associated with a digital ad or per each click-through (“click”) associated with a digital ad.

When an ad provider serves a non-guaranteed digital ad, the ad provider generally determines which non-guaranteed digital ad to serve based at least in part on a bid price associated with a digital ad. A bid price is the amount of compensation an advertiser agrees to provide an ad provider based on an action associated with the served digital ad. Due to the strong competition among advertisers to have ad providers serve their non-guaranteed digital ads, improved systems and methods for setting bid prices associated with digital ads are desirable.

### BRIEF DESCRIPTION OF THE DRAWINGS

FIG. 1 is a block diagram of one environment in which a system for setting bid prices associated with digital ads based on market conditions may operate;

FIG. 2 is a block diagram of one embodiment of a system for setting bid prices associated with digital ads based on market conditions; and

FIG. 3 is a flow chart of one embodiment of a method for setting bid prices associated with digital ads based on market conditions.

### DETAILED DESCRIPTION OF THE INVENTION

The present disclosure is directed to systems and methods for setting bid prices associated with digital ads that an ad provider serves on a non-guaranteed basis where an advertiser agrees to compensate the ad provider based on a cost-per-click basis. The systems and methods described below automatically change bid prices associated with digital ads by reacting to market conditions rather than attempting to predict and optimize bid prices. The digital ads may be sponsored search listings, graphical ads, graphical ads based on sponsored search listings, video ads, or any other type of online marketing media sold on a cost-per-click basis. By reacting to market conditions, an ad campaign management system may set a bid price associated with a digital ad without predicting a number of expected impressions associated with a bid price and without having direct control over a delivery schedule of a digital ad.

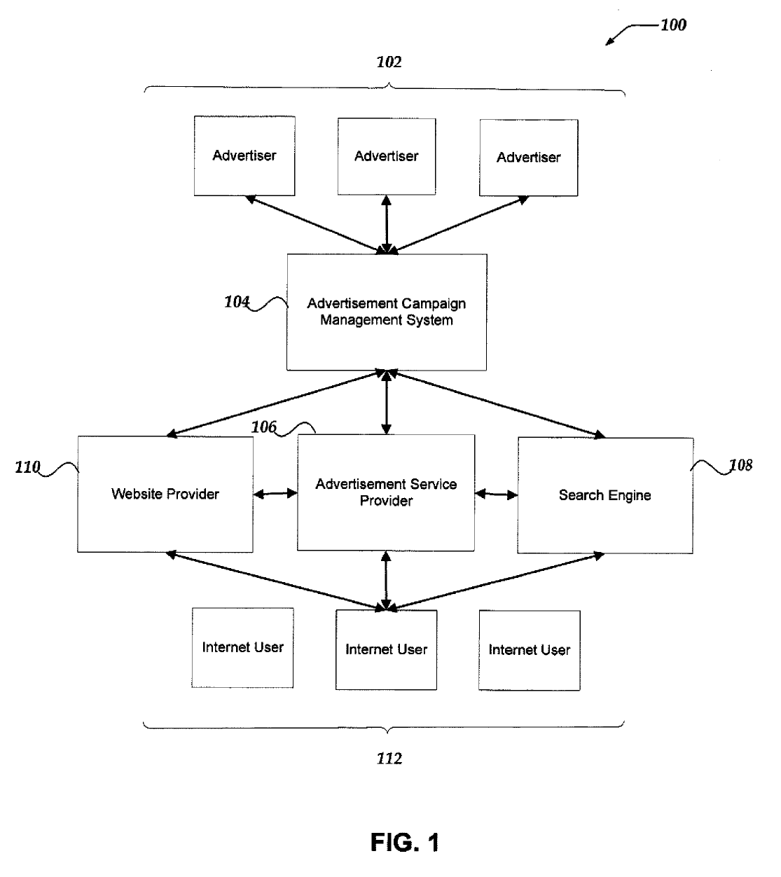

FIG. 1 is a block diagram of one environment in which a system for setting bid prices associated with digital ads based on market conditions may operate. However, it should be appreciated that the systems and methods described below are not limited to use with a search engine or pay-for-placement online advertising.

The environment 100 may include a plurality of advertisers 102, an ad campaign management system 104, an ad provider 106, a search engine 108, a website provider 110, and a plurality of Internet users 112. Generally, an advertiser 102 bids on terms and creates one or more digital ads by interacting with the ad campaign management system 104 in communication with the ad provider 106. The advertisers 102 may purchase ad placements for the placement of digital ads based on an auction model of buying ad space (a non-guaranteed delivery model), or a guaranteed delivery model by which an advertiser may pay a minimum cost-per-thousand impressions (i.e., CPM) to display the digital ad. Typically, the advertisers 102 may pay additional premiums for certain targeting options, such as targeting by demographics, geography, technographics or context. The digital ad may be a graphical ad that appears on a website viewed by Internet users 112, a sponsored search listing that is served to an Internet user 112 in response to a search performed at a search engine, a video ad, a graphical ad based on a sponsored search listing, and/or any other type of online marketing media known in the art.

When an Internet user 112 performs a search at a search engine 108, the search engine 108 may return a plurality of search listings to the Internet user. The ad provider 106 may additionally serve one or more digital ads to the Internet user 112 based on search terms provided by the Internet user 112. In addition or alternatively, when an Internet user 112 views a website served by the website provider 110, the ad provider 106 may serve one or more digital ads to the Internet user 112 based on factors such as keywords obtained from the content of the website or through behavioral targeting.

When the search listings and digital ads are served, the ad campaign management system 104, the ad provider 106, and/or the search engine 108 may record and process information associated with the served search listings and digital ads for purposes such as billing, reporting, or ad campaign optimization. For example, the ad campaign management system 104, ad provider 106, and/or search engine 108 may record the search terms that caused the search engine 108 to serve the search listings; the search terms that caused the ad provider 106 to serve the digital ads; whether the Internet user 112 clicked on a URL associated with one of the search listings or digital ads; what additional search listings or digital ads were served with each search listing or each digital ad; a rank of a search listing when the Internet user 112 clicked on the search listing; a rank or position of a digital ad when the Internet user 112 clicked on a digital ad; and/or whether the Internet user 112 clicked on a different search listing or digital ad when a digital ad, or a search listing, was served. One example of an ad campaign management system that may perform these types of actions is disclosed in U.S. patent application Ser. No. 11/413,514, filed Apr. 28, 2006, and assigned to Yahoo! Inc., the entirety of which is hereby incorporated by reference. It will be appreciated that the systems and methods described below for setting bid prices associated with digital ads based on market conditions may operate in the environment of FIG. 1.

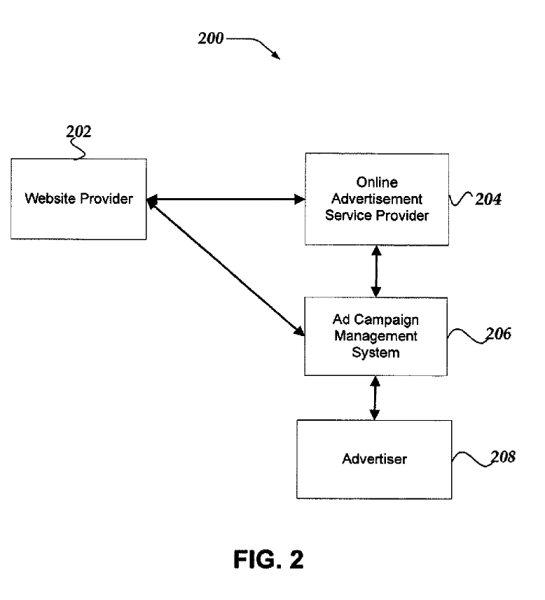

FIG. 2 is a block diagram of one embodiment of a system for setting bid prices associated with digital ads based on market conditions. Generally, the system 200 may include a website provider 202, an ad provider 204, and an ad campaign management system 206. In some implementations the ad campaign management system 206 may be part of the ad provider 204. However, in other implementations, the ad campaign management system 206 is distinct from the ad provider 204.

The website provider 202, ad provider 204, and ad campaign management system 206 may communicate with each other over one or more external or internal networks. The networks may include local area networks (LAN), wide area networks (WAN), and the Internet, and may be implemented with wireless or wired communication mediums such as wireless fidelity (WiFi), Bluetooth, landlines, satellites, and/or cellular communications. Further, the website provider 202, ad provider 204, and ad campaign management system 206 may be implemented as software code running in conjunction with a processor such as a single server, a plurality of servers, or any other type of computing device known in the art.

Generally, an advertiser 208 interacts with the ad campaign management system 206 to create an ad campaign including one or more digital ads that the ad provider 204 will serve to Internet users. As part of creating the ad campaign, the advertiser 208 may set ad campaign parameters at an ad campaign level, an ad group level or an individual digital ad level. Examples of ad campaign parameters set by the advertiser 208 include an ad campaign duration, an ad campaign budget, and a contractual cost-per-click (“contractual CPC”).

An ad campaign duration typically defines a start and end date of an ad campaign. In one implementation, the advertiser 208 may provide the ad campaign management system 206 with actual start and ends dates of the ad campaign, whereas in other implementations, the advertiser 208 may indicate that the ad campaign should start running immediately and provide the ad campaign management system 206 with a number of days the ad campaign should run.

The ad campaign budget provided by the advertiser 208 is a maximum amount of money the advertiser 208 is willing to pay the ad provider 204 for clicks associated with digital ads during the ad campaign. The contractual CPC provided by the advertiser 208 is the maximum amount the advertiser 208 is willing to pay the ad provider 204 per click on the digital ads of the advertiser 208.

The ad campaign management system 206 determines a segmented budget for the ad campaign based on the ad campaign duration and ad campaign budget. The segmented budget may be an hourly budget, a daily budget, a weekly budget, a monthly budget, or any other segmentation of time desired by the ad campaign management system 206.

The ad campaign management system 206 runs the ad campaign for a period of time to determine a click-through rate (“CTR”) and an initial actual cost-per-click (“actual CPC”) associated with at least one digital ad of the ad campaign. It will be appreciated that the CTR associated with a digital ad is typically a function of a quality of the digital ad so that the CTR associated with the digital ad should remain constant until the digital ad is changed.

The actual CPC is the actual cost to the ad provider to serve the digital ad. In one implementation, the actual CPC of a digital ad is calculated using the equation:

$$Actual CPC = \frac{bid * impressions}{clicks} ,$$

where bid is a bid price associated with the digital ad, impressions is a number of times the ad provider served the digital ad, and clicks is the number of times Internet users click on the digital ad.

The ad campaign management system 206 sets a calculated cost-per-click (“calculated CPC”) based on factors such as the contractual CPC, the actual CPC, and the segmented budget associated with the digital ad. The calculated CPC is a cost-per-click value that reacts to a contractual CPC and an actual CPC. This calculated CPC is then used to set a bid price associated with a digital ad. In one implementation, the ad campaign management system 206 sets a bid price associated with the digital ad for a subsequent segment of the ad campaign using the equation:

New bid price=CalculatedCPC*CTR.

The subsequent segment of the ad campaign may be the next hour of the ad campaign, the next day of the ad campaign, the next week of the ad campaign, the next month of the ad campaign, or any other period of time desired by the ad campaign management system 206.

It will be appreciated that the ad campaign management system 206 adjusts the bid price associated with the digital ad for each segment of the ad campaign to optimize a level of traffic driven to a webpage associated with the digital ad while staying within the ad campaign budget.

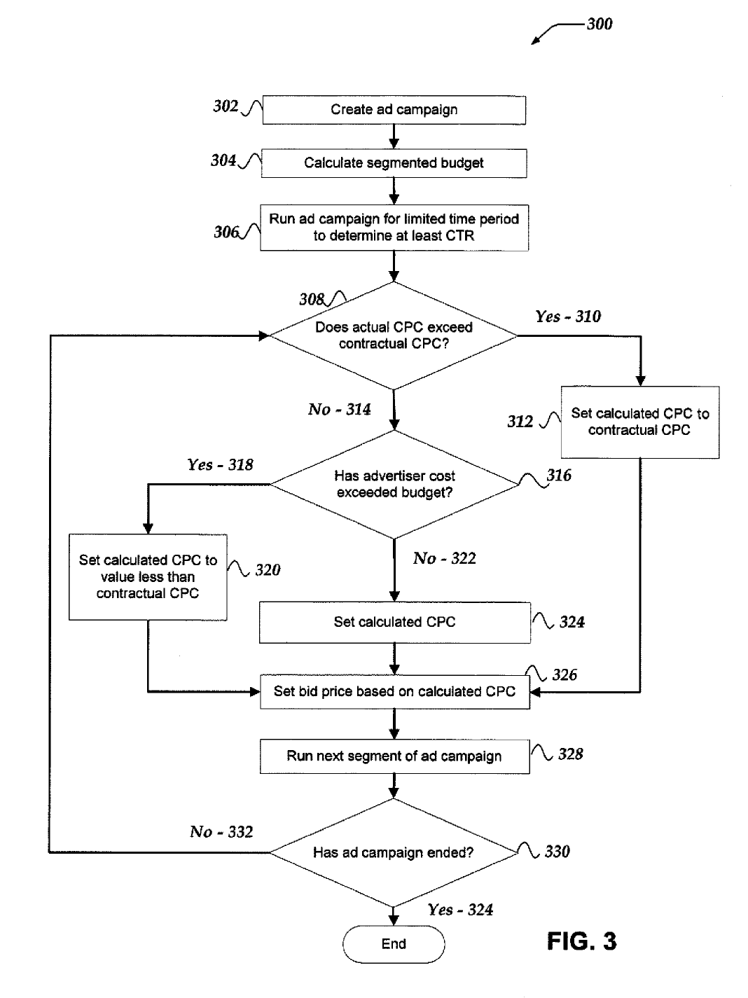

FIG. 3 is a flow chart of one embodiment of a method for setting bid prices associated with digital ads based on market conditions. While the method described below is described with respect to an ad campaign including one digital ad, it should be appreciated that the same method would be employed for an ad campaign including multiple digital ads.

The method 300 begins at step 302 with an advertiser interacting with an ad campaign management system to create an ad campaign including a digital ad. As discussed above, as part of creating the ad campaign, the advertiser sets ad campaign parameters such as an ad campaign duration, an ad campaign budget, and a contractual CPC. The advertiser may set the ad campaign parameters at an ad campaign level, an ad group level, or an individual digital ad level.

At step 304, the ad campaign management system calculates a segmented budget based on the ad campaign duration and the ad campaign budget. In one implementation, the ad campaign management system calculates the segmented budget so that the ad campaign budget is divided evenly among each segment of the ad campaign. However in other implementations, the ad campaign management system calculates the segmented budget so that the ad campaign budget is not divided evenly among each segment of the ad campaign. For example, based on parameters provided by an advertiser, the ad campaign management system may calculate the segmented budget so that 75% of the ad campaign budget is spent in the first half of the ad campaign and the remaining 25% of the ad campaign budget is spent in the second half of the ad campaign.

At step 306, the ad campaign management system runs the ad campaign including the digital ad for a limited period to determine a CTR and an initial actual CPC associated with the digital ad.

At step 308, the ad campaign management system determines whether the actual CPC exceeds the contractual CPC. When the actual CPC exceeds the contractual CPC, the cost to the ad provider to serve the digital ad is more than the ad provider is receiving from the advertiser based on clicks on the digital ad. In other words, when the actual CPC exceeds the contractual CPC, the ad provider is losing money.

Typically, when serving non-guaranteed digital ads, an ad provider determines which digital ad to serve based at least in part on cost-per-mille (“CPM”) values associated with the digital ads. A CPM of a digital ad is defined to be a product of the CPC associated with the digital ad and the CTR associated with the digital ad. When the ad provider serves a digital ad, an opportunity cost for serving the digital ad is equal to the CPM associated with the digital ad because the same amount of money could have been spent on another digital ad. Therefore, when the actual CPC exceeds the contractual CPC, the opportunity costs associated with serving the digital ad over the segment of the ad campaign is more than the revenue being generated by Internet users clicking on the digital ad during the same segment of the ad campaign.

For this reason, when the actual CPC exceeds the contractual CPC (branch 310), the calculated CPC for the digital ad is set to the contractual CPC associated with the digital ad at step 312 so that the cost to an ad provider to serve a digital ad during a segment of the ad campaign is not more than the revenue generated by Internet user clicking on the served digital ad during that segment of the ad campaign. The method then proceeds to step 326.

When the actual CPC does not exceed the contractual CPC (branch 314), the cost to the ad provider to serve the digital ad is not more than the revenue generated by Internet user clicking on the served digital ad and the method proceeds to step 316. At step 316, the ad campaign management system determines whether a cost to the advertiser for a segment of the ad campaign exceeds the segmented budget for that segment of the ad campaign, For example, the ad provider may determine if the cost associated with the digital ad for a day exceeds the daily budget of the ad campaign for that day. In one implementation, the cost to an advertiser for a segment is calculated as a product of a current bid price associated with the digital ad and a number of clicks on the digital ad during that segment of the ad campaign.

When the cost to the advertiser for a segment of the ad campaign exceeds the segmented budget for that segment of the ad campaign (branch 318), the advertiser has exceeded the segmented budget of the ad campaign. Therefore, the ad campaign management system sets the calculated CPC to a value less than the contractual CPC at step 320 to reduce the cost to the advertiser during the next segment of the ad campaign and bring the overall cost of the ad campaign to within the ad campaign budget. The method then proceeds to step 326.

In one implementation, at step 320, the ad campaign management system may set the calculated CPC to a value between the contractual CPC and a fraction of the actual CPC to reduce the cost to the advertiser during the next segment of the ad campaign, such as a minimum value between the contractual CPC and half the actual CPC associated with the digital ad.

When the cost to the advertiser for a segment of the ad campaign does not exceed the segmented budget for that segment of the ad campaign (branch 322), the advertiser has not exceeded the segmented budget associated with the ad campaign. If the ad campaign management system has not set a value for a calculated CPC during a previous segment of the ad campaign, the ad campaign management system sets the calculated CPC to be equal to the actual CPC at step 324. However, if the ad campaign management system has previously set a value for a calculated CPC, the ad campaign management system sets the calculated CPC as a predetermined increase of a calculated CPC from a previous segment of the ad campaign at step 324, such as a 10% increase in a particular implementation.

Increasing the calculated CPC will increase the bid price associated with a digital ad during a next segment of the ad campaign, which typically results in an increase in a number of times the ad provider serves the digital ad during the next segment of the ad campaign, an increase in a number of user driven to a webpage associated with the digital ad during the next segment of the ad campaign, and an increase in revenue for the ad provider created by users clicking on the served digital ad during the next segment of the ad campaign.

At step 326, the ad campaign management system sets a bid price associated with the digital ad for the next segment of the ad campaign based on the calculated CPC. The ad campaign management system sets the bid price as a product of the calculated CPC and the CTR associated with the digital ad,

At step 328, the ad campaign is run for the next segment of the ad campaign with the bid price set at step 326, resulting in a new actual CPC. In some implementations the actual CPC may be the actual CPC determined by the ad campaign management system during a previous segment of the ad campaign, whereas in other implementations, the actual CPC is an average of the actual cost to an ad provider to serve a digital ad over the expired portion of the ad campaign.

At step 330, the ad campaign management system determines whether the ad campaign has ended. If there is at least one remaining segment of the ad campaign (branch 332), the method loops to step 308 and the above-described process is repeated using the new actual CPC. However, if there are no remaining segments of the ad campaign (branch 334), the method ends.

FIGS. 1-3 teach systems and methods for setting bid prices associated with digital ads based on market conditions. By automatically changing bid prices associated with digital ads based on market conditions, an ad campaign management system may set a bid price associated with a digital ad without an ad campaign management system employing methods to optimize bid prices based on a prediction of a number of expected impressions associated with a specific bid price during an ad campaign.

It is therefore intended that the foregoing detailed description be regarded as illustrative rather than limiting, and that it be understood that it is the following claims, including all equivalents, that are intended to define the spirit and scope of this invention.

1. A method for setting a bid price associated with a digital ad, the method comprising the steps of;
calculating a segmented budget for an ad campaign comprising a digital ad;
running the ad campaign for a defined period of time to determine at least a click-through rate associated with the digital ad;
examining an actual cost-per-click (“actual CPC”) and a contractual cost-per-click (“contractual CPC”) associated with the digital ad to determine a calculated cost-per-click (“calculated CPC”) associated with the digital ad for a segment of the ad campaign; and
setting a bid price for the digital ad based on the calculated CPC for a future segment of the ad campaign.

2. The method of claim 1 wherein examining the actual CPC and the contractual CPC to determine the calculated CPC for a segment of the ad campaign comprises:
setting the calculated CPC to be equal to the contractual CPC when the actual CPC exceeds the contractual CPC.

3. The method of claim 1, wherein examining the actual CPC and the contractual CPC to determine the calculated CPC for a segment of the ad campaign comprises:
setting the calculated CPC to a value less than the contractual CPC to reduce a cost to an advertiser during the next segment of the ad campaign when a cost for the advertiser exceeds a segmented budget of the segment of the ad campaign.

4. The method of claim 3, where the calculated CPC is set to a minimum value between the contractual CPC and half of the actual CPC when the cost for an advertiser exceeds a segmented budget of the segment of the ad campaign.

5. The method of claim 3, wherein the cost of an advertiser is equal to a product of the contractual CPC and a number of clicks on the digital ad during the segment of the ad campaign.

6. The method of claim 1, wherein examining the actual CPC and the contractual CPC to determine the calculated CPC for a segment of the ad campaign comprises:
increasing a value of the calculated CPC when the actual CPC is not greater than the contractual CPC and a cost for an advertiser does not exceed a segmented budget of the segment of the campaign.

7. The method of claim 1, where setting a bid price for the digital ad based on the calculated CPC comprises:
setting the bid price to a value equal to a product of the calculated CPC and the click-through rate.

8. The method of claim 1, wherein the segmented budget is one of an hour budget, a daily budget, a weekly budget, and a monthly budget.

9. The method of claim 1, wherein the bid price associated with the first digital ad is set for one of a next hour of the ad campaign, a next day of the ad campaign, a next week of the ad campaign, and a next month of the ad campaign.

10. A computer-readable storage medium comprising a set of instructions for setting a bid price associated with a digital ad, the set of instructions to direct a processor to perform acts of:
calculating a segmented budget for an ad campaign comprising a digital ad;
running the ad campaign for a defined period of time to determine at least a click-through rate associated with the digital ad;
examining an actual cost-per-click (“factual CPC”) and a contractual cost-per-click (“contractual CPC”) associated with the digital ad to determine a calculated cost-per-click (“calculated CPC”) associated with the digital ad for a segment of the ad campaign; and
setting a bid price for the digital ad based on the calculated CPC for a future segment of the ad campaign.

11. The computer-readable storage medium of claim 10, wherein examining the actual CPC and the contractual CPC to determine the calculated CPC for a segment of the ad campaign comprises:
setting the calculated CPC to be equal to the contractual CPC when the actual CPC exceeds the contractual CPC.

12. The computer-readable storage medium of claim 10, wherein examining the actual CPC and the contractual CPC to determine the calculated CPC for a segment of the ad campaign comprises:
setting the calculated CPC to a value less than the contractual CPC to reduce a cost to an advertiser during the next segment of the ad campaign when a cost for the advertiser exceeds a segmented budget of the segment of the ad campaign.

13. The computer-readable storage medium of claim 10, wherein examining the actual CPC and the contractual CPC to determine the calculated CPC for a segment of the ad campaign comprises:
increasing a value of the calculated CPC when the actual CPC is not greater than the contractual CPC and a cost for an advertiser does not exceed a segmented budget of the segment of the campaign.

14. The computer-readable storage medium of claim 10, wherein the segmented budget is one of an hour budget, a daily budget, a weekly budget, and a monthly budget.

15. The computer-readable storage medium of claim 10, wherein the bid price associated with the first digital ad is set for one of a next hour of the ad campaign, a next day of the ad campaign, a next week of the ad campaign, and a next month of the ad campaign.

16. A system for setting a bid price associated with a digital ad, the system comprising:
an ad campaign management system operative to calculate a segmented budget for an ad campaign comprising a digital ad, to run the ad campaign for a defined period of time to determine at least a click-through rate associated with the digital ad, to examine an actual cost-per-click (“actual CPC”) and a contractual cost-per-click (“contractual CPC”) associated with the digital ad to determine a calculated cost-per-click (“calculated GPC”) associated with the digital ad for a segment of the ad campaign, and to set a bid price for the digital ad based on the calculated CPC for a future segment of the ad campaign.

17. The system of claim 16, wherein the ad campaign management system is further operative to set the calculated CPC to be equal to the contractual CPC when the actual CPC exceeds the contractual CPC.

18. The system of claim 16, wherein the ad campaign management system is further operative to set the calculated CPC to a value less than the contractual CPC to reduce a cost to an advertiser during the next segment of the ad campaign when a cost for the advertiser exceeds a segmented budget of the segment of the ad campaign

19. The system of claim 16, wherein the ad campaign management system is further operative to increase a value of the CPC when the actual GPO is not greater than the contractual CPC and a cost for an advertiser does not exceed a segmented budget of the segment of the campaign.

20. The system of claim 16, wherein the segmented budget is one of an hour budget, a daily budget, a weekly budget, and a monthly budget.

21. The system of claim 16, wherein the bid price associated with the first digital ad is set for one of a next hour of the ad campaign, a next day of the ad campaign, a next week of the ad campaign, and a next month of the ad campaign.
